(19) United States
(12) Patent Application Publication
(10) Pub. No.: US 2025/0245766 A1
(43) Pub. Date: Jul. 31, 2025

(54) SYSTEMS AND METHODS FOR AUTOMATED GENERATION OF REQUESTS ACROSS DISPARATE ENTITIES

(71) Applicant: RiskJockey, Inc., Roswell, GA (US)

(72) Inventors: Michael A. Connell, Alpharetta, GA (US); Andrew Bone, Cumming, GA (US)

(21) Appl. No.: 19/040,483

(22) Filed: Jan. 29, 2025

Related U.S. Application Data
(60) Provisional application No. 63/627,668, filed on Jan. 31, 2024.

(51) Int. Cl. G06Q 50/26; G06Q 50/40; G06V 30/10

(52) U.S. Cl. CPC G06Q 50/265; G06Q 50/40; G06V 30/10

(57) ABSTRACT

Systems and methods for automated generation of requests across disparate entities are provided. A method includes: receiving an incident report; extracting context information associated with the incident report, wherein the context information comprises a set of attributes associated with an incident; generating a set of contacts and a set of messages to be sent to the set of contacts based at least in part on the context information and an identity of a requesting user; transmitting the set of messages to the set of contacts; and generating and outputting, responsive to receiving information from the set of contacts, a context specific report containing the information received from the set of contacts.

### CROSS-REFERENCE TO RELATED APPLICATION

This application claims priority to U.S. Provisional Patent Application No. 63/627,668, titled “SYSTEMS AND METHODS FOR AUTOMATED GENERATION OF REQUESTS ACROSS DISPARATE ENTITIES,” filed Jan. 31, 2024, the entirety of which is hereby incorporated by reference.

### TECHNICAL FIELD

This disclosure generally relates to information collection and report generation. More specifically, but not by way of limitation, this disclosure relates to systems and methods for automatically generating requests for information across disparate entities, generating reports based on electronic collections of data, and providing the reports in an interactive user interface.

### BACKGROUND

A conventional approach to investigation of traffic incidents involves receiving a motor incident report containing information held by multiple investigative and supporting agencies (e.g., disparate entities). In some cases, a single motor incident report can involve as many as eight individual investigative or supporting agencies all of which hold valuable evidence regarding the traffic incident. Some of the investigative or supporting agencies can include, for example, the state patrol's office, the state's department of transportation office, the National Highway Traffic Safety Administration (NHTSA), emergency communication responders, the Federal Motor Carrier Safety Administration (FMCSA), the state bureau of investigation, and the county and local police. Given that numerous agencies are in possession of evidence, serious problems arise for claims adjusters, attorneys, citizens, or the like who seek to obtain the information for their usage. Securing all the necessary evidence, such as body-camera video, can be very time consuming, and often times evidence is not secured by the parties in need of it due to the immense effort involved. As a result of this problem, millions of dollars are expended annually in needless litigation or is lost in settlement actions over traffic incidents that can be avoided if access to information was more streamlined.

Accordingly, a new way collecting information from disparate entities, which is not reliant upon individual human requests, is desired. This is especially true where incidents involve a large number of investigative or supporting agencies. Such large amounts of disparate entities coupled with human inefficiencies can result in extreme difficulty and slow speed in obtaining necessary information.

### SUMMARY

Examples described in the present disclosure address the above-mentioned problems by providing a system for automatically generating requests for information, obtaining all requested information, and generating a report in an efficient and streamlined manner. According to an aspect of the present disclosure, a method for automatic generation of requests for information includes receiving an incident report and extracting context information associated with the incident report. The context information includes a set of attributes associated with an incident. The method also includes generating a set of contacts and a set of messages to be sent to the set of contacts based at least in part on the context information and an identity of a requesting user. The method also includes transmitting the set of messages to the set of contacts. The method also includes generating and outputting, responsive to receiving information from the set of contacts, a context specific report containing the information received from the set of contacts.

The above methods may be implemented in a cloud service executed on cloud service provider infrastructure, which may include various servers, processors, and databases. The above methods can also be implemented as computer-executable program instructions stored in a non-transitory, tangible computer-readable medium or media and/or operating within a system including one or more processors or other processing device and memory.

An additional examples includes a system including one or more processors. The system also includes a memory coupled to the one or more processors. The memory includes instructions that when executed by the one or more processors, causes the one or more processors to receive an incident report and extract context information associated with the incident report. The context information includes a set of attributes associated with an incident. The instructions further cause the one or more processors to generate a set of contacts and a set of messages to be sent to the set of contacts based at least in part on the context information and an identity of a requesting user. The instructions further cause the one or more processors to transmit the set of messages to the set of contacts. The instructions further cause the one or more processors to generate and output, responsive to receiving information from the set of contacts, a context specific report containing the information received from the set of contacts.

An additional example includes a non-transitory computer-readable medium embodying program code that is executable by one or more processors to cause the one or more processors receive an incident report and extract context information associated with the incident report. The context information includes a set of attributes associated with an incident. The instructions further cause the one or more processors to generate a set of contacts and a set of messages to be sent to the set of contacts based at least in part on the context information and an identity of a requesting user. The instructions further cause the one or more processors to transmit the set of messages to the set of contacts. The instructions further cause the one or more processors to generate and output, responsive to receiving information from the set of contacts, a context specific report containing the information received from the set of contacts.

This summary is not intended to identify the key or essential features of the claimed subject matter, nor is it intended to be used in isolation to determine the scope of the claimed subject matter. Rather, the summary is merely a simplified and non-limiting summary of the innovation that is intended to provide a basic understanding of some aspects of the innovation. The subject matter should be understood by reference to appropriate portions of the entire specification of this disclosure, any or all drawings, and each claim.

To the accomplishment of the foregoing and related ends, certain illustrative aspects of the innovation are described herein in connection with the following description and the annexed drawings. These aspects are indicative, however, of but a few of the various ways in which the principles of the innovation may be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Various non-limiting embodiments are further described with reference to the accompanying drawings, in which:

FIG. 1 illustrates an example system for automatic generation of requests across disparate entities, according to one or more aspects of the present disclosure;

FIG. 2 illustrates an example network interface for automatic generation of requests across disparate entities according to one or more aspects of the present disclosure;

FIG. 3 illustrates a flow chart for a method of automatic generation of requests across disparate entities according to an aspect of the present disclosure;

FIG. 4 illustrates a flow chart for a method of automatic generation of requests across disparate entities according to another aspect of the present disclosure;

FIG. 5 illustrates an example motor vehicle incident report according to one or more aspects of the present disclosure;

FIG. 6 illustrates an example of a disparate entity according to one or more aspects of the present disclosure;

FIG. 7 illustrates an example of another disparate entity according to one or more aspects of the present disclosure;

FIG. 8 illustrates an example set of disparate entities according to one or more aspects of the present disclosure; and

FIG. 9 illustrates an example of an automated request for information according to one or more aspects of the present disclosure.

### DETAILED DESCRIPTION

Examples described herein relate to systems, devices, and methods for automatically requesting information from a plurality of disparate entities. More specifically, the disclosure relates to systems and methods for automatically identifying the sources of information (e.g., investigative or supporting agencies) related to incidents and once identified, automatically requesting information from the plurality of agencies via legally compliant requests and generating a report of the received information. The systems and methods disclosed herein can be interactive such that a user can make selections and provide inputs.

According to an illustrative example of the present disclosure, a system for automatically generating requests for information is provided. The system includes a processor that is coupled to a memory. The memory includes instructions that, when executed by the processor, cause the processor to receive an incident report and extract context information associated with the incident report. The context information includes a set of attributes associated with the incident such as a time, date, location (e.g., county, state, GPS coordinates), party names, and so on. Based on the incident report and the extracted context information as well as a determined identity of a requesting user, the processor generates a set of contacts and a set of messages to be sent to the set of contacts. The processor can transmit the set of messages to the set of contacts and then create and output a context specific report that includes information received from the set of contacts. In some examples, the processor can further generate additional messages to be displayed. In some examples, the additional messages can indicate whether certain requested information was unavailable or not received. The additional message can also provide an option to share the context specific report with other disparate entities.

The above-described system can further include a network interface and input/output (I/O) peripherals. The network interface can facilitate communications between the system and one or more other devices. The I/O peripherals can be connected to a display device that includes an input device and an output device. The input device and the output can be interactive such that a user can interact with the input device and view information on the output device. In some examples, the processor, the memory, the storage device, the I/O peripherals, and the network interface can be connected via an interface bus within the system. In addition, the above-described system can further include a storage device. The storage device can include additional storage that is removable or non-removable. The storage device can store computer readable instructions to implement an operating system, an application program, and the like that can be accessed in the memory for execution on the one or more processors

Continuing on with the illustrative example, an in some examples, extracting the context information can further include scanning (e.g., using optical character recognition (OCR)) the incident report and identifying, based on the scan, a precise location of the incident. For example, the precise location can correspond to global positioning system coordinates corresponding to a latitude and longitude, a street address, and so on. Additionally, the step of scanning the incident report can include using any suitable OCR techniques to scan the incident report (e.g., extract text date from an image file). In some examples, the OCR techniques may be used to identify a unique document identifier contained within the incident report, such as a barcode. The unique document identifier can contain information related to the incident (e.g., linking the scanning user to a webpage or otherwise providing the scanning user with additional information associated with the incident). A barcode can be any form of a machine-readable optical image that contains information, such as a quick response code (QR), a universal product code (UPC), a data matrix, and the like.

Other examples described herein may incorporate machine learning techniques. For instance, after scanning a incident report for a precise location, the precise location can be evaluated using a machine learning model trained by processing previous incident reports and their corresponding precise locations. The machine learning model can generate the set of contacts. The set of contacts can correspond to disparate entities holding relevant evidence related to the incident. As the machine learning can be trained by processing previous incident reports and their corresponding precise locations, the machine learning model can learn from past incident reports, past generations of the set of contacts, and past requests for information and their relative success rates in retrieving information related to an incident. Based on the relative success rates, the machine learning model can determine whether modifications should be made to the present set of contacts and requests for information to increase the likelihood of receiving the relevant information.

Furthermore, the machine learning model can determine, based on a classification of a user of the system (e.g., private citizen, attorney, claims adjustor, etc.) which information to request. For example, the machine learning model can identify that the user is an attorney investigating an incident for purposes of a personal injury lawsuit. Accordingly, the machine learning model can identify, based on previous incidents involving attorneys and personal injury, that contacting the responding police department for body-camera footage of the scene to illustrate the injuries present at the time of the incident is the most valuable type of information for this type of user classification. Based on this determination, the machine learning model can generate a set of contacts (e.g., the local responding police department) and a set of messages containing legally compliant requests for information to obtain the body camera footage from the incident.

Yet another particular example described herein involves a method for automatically generating requests for information related to an incident is provided. The method includes receiving, from a global positioning device, location information corresponding to the incident. In some examples, the location information can correspond to GPS (GPS) coordinates corresponding to a latitude and longitude. The method also includes evaluating the location information to generate a set of contacts. The set of contacts can correspond to disparate entities holding relevant evidence related to the incident. The method also includes generating a set of messages to be sent to the set of contacts. The set of messages can be requests for information based on the location information. The method also includes receiving information from the set of contacts and generating a context specific report based on the received information. The method also includes displaying the context specific report.

Examples of the present disclosure generally relate to automatic generation of requests for information. While some examples are described in the context of a vehicle incident, the examples described herein can be implemented to automatically generate requests for information response to any type of incident involving disparate entities holding information relevant to the incident where one is interested in knowing and/or collecting information related to the incident. For instance, automatic generation of requests for information may be applied to premise liability reports, arrest reports, medical incident reports, products liability report, emergency response reports (e.g., fire, police, medical), and so on.

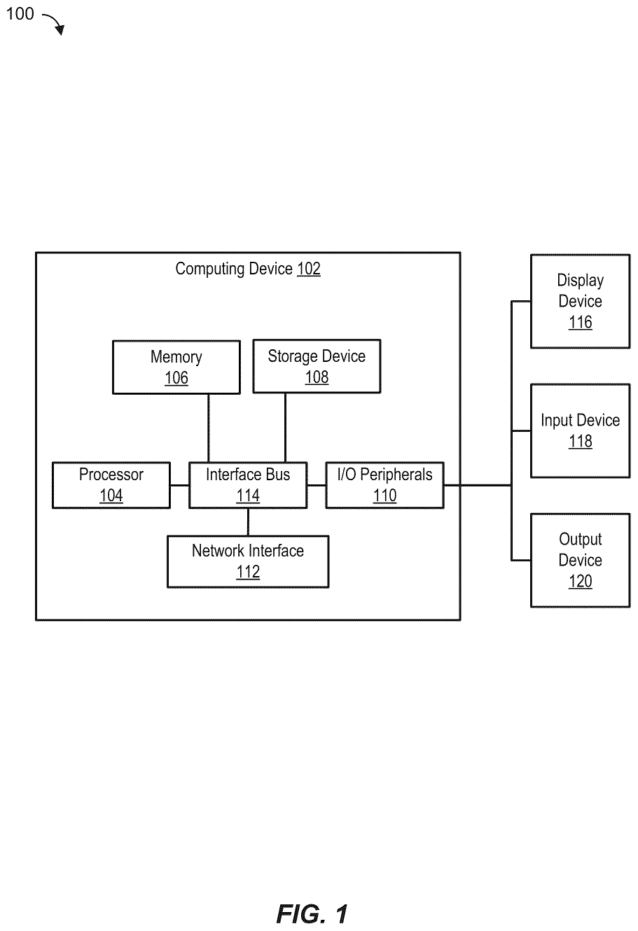

Referring now to the figures, FIG. 1 illustrates a system 100 including a computing device 102 operable to implement one or more examples provided herein. In one example, the computing device 102 can include at least one processor 104, a memory 106, I/O peripherals 110, and a network interface 112 all connected along an interface bus 114. The interface bus 114 can communicate, transmit, and transfer data, controls, and commands among the various components of the system 100.

In the example illustrated by FIG. 1, the computing device 102 can include additional features or functionality. For example, the computing device 102 can also include additional storage such as a storage device 108. The storage device 108 can be removable storage or non-removable storage, including, but not limited to, magnetic storage, optical storage, and the like. The storage device 108 can store computer readable media comprising computer readable instructions to implement an operating system, an application program, and the like. The computer readable instructions can be accessed in the memory 106 for execution on the processor 104. For example, the processor 104 can execute the stored computer readable instructions and the processor 104 can include, for example, a logical processing unit, a microprocessor, a digital signal processor, and other processors. Although not illustrated in FIG. 1, the memory 106 and/or the processor 104 can be virtualized and can be hosted within another computing system of, for example, a cloud network or a data center. One of ordinary skill in the art would recognize many further combinations, permutations, and alternatives.

The term “computer readable media” as used herein includes computer storage media. Computer storage media includes volatile and nonvolatile, non-transitory, removable and non-removable media implemented in any method of technology for storage of information such as computer-readable instructions or other data. The memory 106 and the storage device 108 are examples of computer storage media. Computer storage media includes, but is not limited to, Random Access Memory (RAM), read-only memory (ROM), electrically erasable programmable read-only memory (EEPROM), hard drives, CD-ROMs, optical storage devices, magnetic storage devices, electronic non-volatile computer storage, for example Flash® memory, and other tangible storage media. Any of such computer-readable storage media can store instructions or program codes embodying aspects of the disclosure.

As further illustrated by FIG. 1, the computing device 102 can include a display device 116, an input device 118, and an output device 120 coupled to the I/O peripherals 110. In some examples, the I/O peripherals 110 can receive as input, data from the input device 118. The I/O peripherals 110 can further send, as output, data processed by the computing device 102 to the output device 120. The output device 120 can send output data provided by the I/O Peripherals 110 to the display device 116 for display. To facilitate communication between the I/O peripherals 110 and the display device 116, the input device 118, and the output device 120, the I/O peripherals 110 can include user interfaces, such as a keyboard, screen (e.g., a touch screen), microphone, speaker, other input/output devices, and computing components, such as graphical processing units, serial ports, parallel ports, universal serial buses, and other I/O peripherals. Further, and to facilitate communication of the I/O peripherals 110 with the other components of the computing device 102, the I/O peripherals are connected along any of the ports coupled to the interface bus 114.

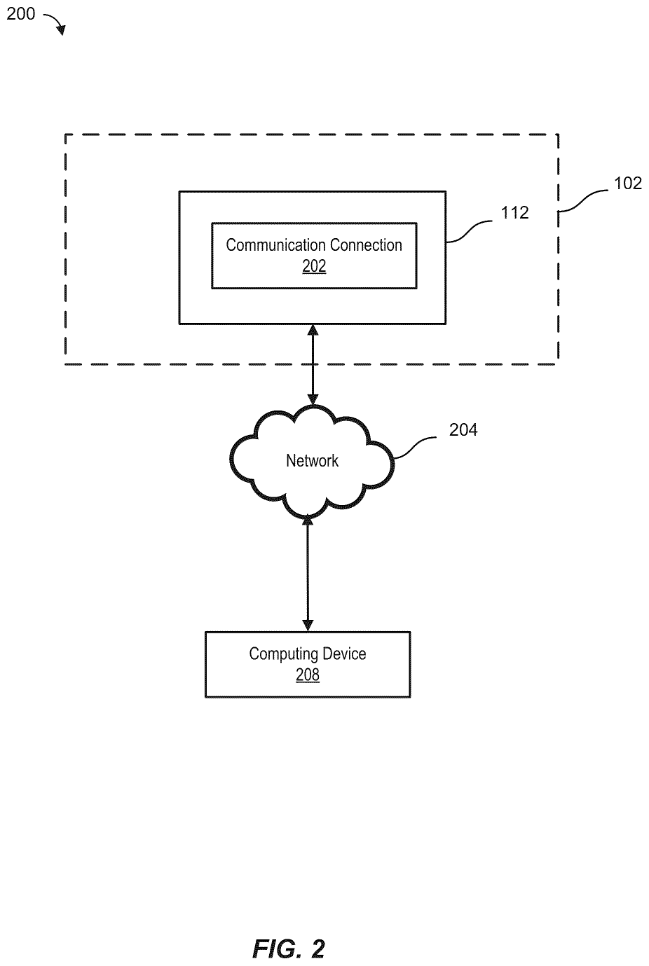

FIG. 2 illustrates a detailed component diagram 200 of the network interface 112. The network interface 112, which is included within the computing device 102, is described above in relation to FIG. 1. As illustrated by FIG. 2, the network interface 112 includes a communication connection 202, which can facilitate communications with one or more other devices, such as a computing device 208, by a network 204. Communication between the network interface 112 and one or more other devices, such as the computing device 208, can be performed via wired communication, wireless communication, or any combination thereof, and can include ad hoc networks, intranets, the Internet, or substantially any other communications network that can enable the system 100 to communicate with at least one other computing device.

With respect to the presently disclosed subject matter, and by way of example, the storage device 108 can include computer readable instructions that instruct a computer to send requests for information across disparate entities in response to input data received by the I/O peripherals 110 from the input device 118. The input data can include information related to a traffic accident such as a vehicle incident report, a precise location via global positioning system (GPS) coordinates, or any other form of user input data disclosed herein. Once received at the I/O peripherals 110, the computer readable instructions stored within the storage device 108 can be accessed in the memory 106 for execution on the processor 104. Based on the precise location of the traffic accident, as determined by the latitude and longitude or GPS coordinates, the processor 104 executes the computer readable instructions to automatically generate requests for information to be sent, via the network interface 112, to the appropriate investigative and supporting agencies (i.e., disparate entities). The disparate entities can include, but are not limited to, the local police office of the reported traffic accident, the state department of transportation, the state patrol office, the department of motor vehicles, the National Highway Traffic Safety Administration (NHTSA), or the Federal Motor Carrier Safety Administration (FMCSA). The requests for information would then be received by the computing device 208. Each disparate entity can utilize their own computing device. Each disparate entity, in response to the request for information, can provide the requested information. The provided information is then communicated back to the communication connection 202. Once all requests for information have been received at the network interface 112, the processor 104 can execute computer readable instructions to generate a context specific report of the requested information. The report can include a summary of all requests made and the processor 104 can organize the received information. The I/O peripherals 110 can send the generated context specific report to the output device 120 for display on the display device 116.

In some examples, the computing device 102 can further cause the processor 104 to analyze user input data using a machine learning model. For example, the storage device 108 can include computer readable instructions that instruct the computing device 102 to scan a vehicle incident report (or other type of incident report, e.g., a premise liability report, arrest report, medical incident report, etc.) for a precise location corresponding to GPS coordinates containing a latitude and a longitude position of a vehicle incident. The processor 104 can execute the instructions to evaluate the precise location using a machine learning model. The machine learning model can be trained by processing previous vehicle incident reports and their corresponding precise location, to generate a set of contacts. The set of contacts can correspond to the disparate entities holding the relevant evidence related to the traffic event. The machine learning model can learn from past vehicle incident reports, past generation of a set of contacts, and past requests for information and their relative success rates in retrieving information related to a vehicle incident. Furthermore, the machine learning model, based on the past success rates, can determine whether modifications should be made to the present set of contacts and requests for information to increase the likelihood of receiving the relevant information. For example, if a particular investigative agency or supporting agency has a historically low rate of replying to requests for information, the machine learning model can assign a heightened flag for that particular agency. In some examples, the heightened flag can indicate to the system that the requested information should be resourced from a different agency so the system does not expend resources in generating the request. In additional examples, the heightened flag can indicate that multiple follow up requests to that agency must be performed to receive the requested information.

Reference herein made to machine learning models are not limited to a specific type of machine learning model. For example, the methods can use various machine learning techniques such as neural networks, trained and untrained classifiers, support vector machines, decision trees, or Bayesian networks to analyze user inputs and determine a set of contacts to send requests for information to. In some examples, after scanning a user inputted vehicle incident report (or other type of incident report), the machine learning model can assign numerical weights to the various portions of the vehicle incident report associated with the location of the vehicle incident, the type of vehicle incident, the responding police department, etc. The machine learning model can the weigh the combination of inputs to determine a set of contacts corresponding to a best plan for retrieving the information based on the set of contacts that are most likely to comply with the records request.

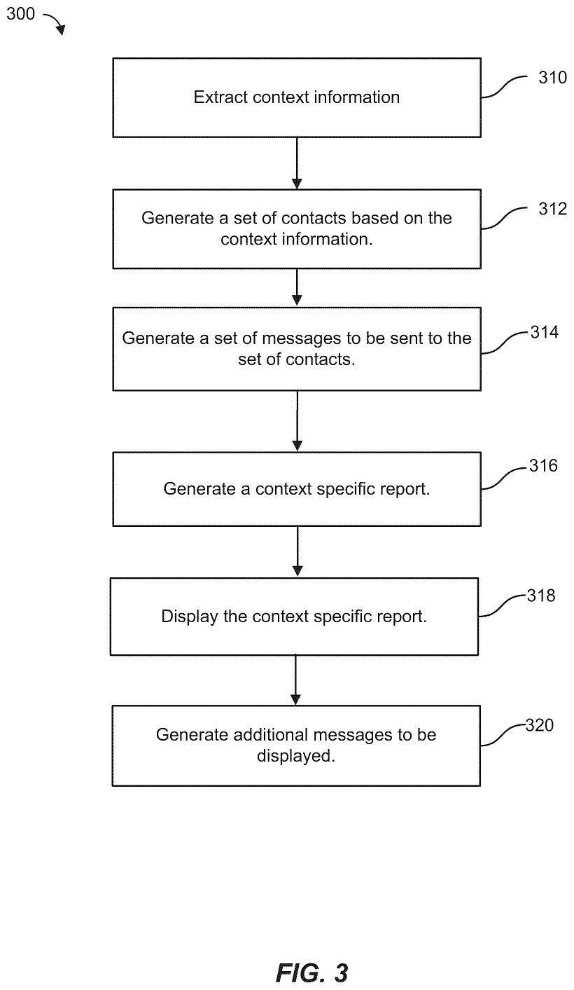

FIG. 3 illustrates a flow chart depicting process 300, according to an example. The process 300 is illustrated as a logical flow chart, each operation of which represents a sequence of operations that can be implemented in hardware, computer instructions, or a combination thereof. For example, the sequence of operations illustrated by process 300 can be implemented on the system 100 described above in relation to FIG. 1 and FIG. 2. In the context of computer instructions, the operations can represent computer-executable instructions stored on one or more non-transitory computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, some, any, or all the processes described herein can be performed under the control of one or more computer systems that include specific executable instructions and can be implemented as code (e.g., executable instructions, one or more computer programs, or one or more applications) executing collectively on one or more processors, by hardware, or combinations thereof. As noted above, the code can be stored on a non-transitory computer-readable storage medium, for example, in the form of a computer program including a plurality of instructions executable by one or more processors.

FIG. 3 illustrates a flow chart depicting process 300 for generating a context specific report from a plurality of disparate entities, according to one example. At block 310, process 300 involves extracting context information. As mentioned with respect to FIGS. 1 and 2, the context information can be associated with any type of incident report, such as a vehicle incident report. In some examples, context information associated with the incident report can refer to global positioning system (GPS) coordinates corresponding to a precise latitude and longitude of the incident. In some examples, and in the case of a vehicle incident, the process can receive the GPS coordinates directly from an entity involved in the vehicle incident (e.g., received directly from a GPS device). In addition, context information can also refer to a incident report number corresponding to a incident report generated, for example, by the police department, fire department, emergency medical technician (EMT), or other disparate entity. Further, in some examples, the context information can refer to a specific date, time, and name of the parties involved in the incident. Furthermore, the context information can include any combination of GPS coordinates, report identification numbers, date, time, or names.

At block 312, process 300 involves generating a set of contacts based on the context information. The set of contacts can be generated via computer readable instructions performed by the processor 104 as discussed above in relation to FIG. 1 and FIG. 2. Additionally, the system 100 can have the capability to learn from previous requests for information through machine learning or artificial intelligence. In this way, at block 312, process 300 can intelligently and autonomously select, based on the context information, the appropriate set of contacts most likely to be in possession of the relevant evidence and information. For instance, the set of contacts may be identified based on a plurality of entities associated with the incident report that are located within a predetermined distance from a precise location of the incident. As another example, the set of contacts may be selected based on relative success rates that the selected set of contacts have had information in the past that has been “of interest” to parties involved in a incident.

As yet another example, the set of contacts may be identified based on jurisdictional information associated with the incident in combination with the predetermined distance information. For instance, and according to a particular example, a user may be involved in a incident that occurs on the edge of a county line, state line, country border, etc. In these scenarios, the process of generating the set of contacts based on the context information can involve detecting, based on the precise location and based on a mapping of the precise location to geographical boundaries (e.g., boundary information may be extract from geographical and publicly available maps), that the incident occurred on an edge portion of a geographical boundary. In these situations, rather than generating a set of contacts based solely on a predetermined distance from the precise location, the process can further involve filtering out contacts that are not included within the jurisdictional boundary where the incident occurred. This process ensures that all the generated contacts and subsequent messages have proper jurisdictional authority over the incident.

At block 314, process 300 involves generating a set of messages to be sent to the set of contacts. The messages can be requests for information corresponding to the context information. The requests for information may be generated from preconfigured templates that are in a format that is compliant with the respective contact. In other words, if a police department is identified as a contact holding information relevant to the incident (e.g., police body camera footage, a police report, etc.) the generated message that is sent to the police department may be preconfigured such that all the mandatory fields that are required by the police department are automatically included in the message without the need for user input (e.g., the relevant information such as date, time, party names, etc. may be extracted from the incident report and automated included in the proper fields for the request for information from the police department).

At block 316, process 300 involves generating a context specific report. The context specific report contains report information received by the system from the set of contacts. The context specific report may organize the received information in a manner that is easily read and viewed by the user. For instance, the processor may organize the information into a table, bullet point form, paragraph form, etc.

At block 318, process 300 involves displaying the context specific report. Display of the context specific report can involve displaying, on a graphical user interface (GUI) of a user computing device, the context specific report. As mentioned previously with respect to FIG. 1, the user may view the context specific and in some cases, the user may share the context specific report with other entities. In some examples, the context specific report can be an interactive GUI such that the displayed information in the context specific report may be automatically or manually adjusted and/or relocated for ease in viewing for the user. For instance, a processor implementing process 300 may track, based on user interaction with the GUI, which “icons” (e.g., data fields) in the context specific report are most frequently selected by the user. Responsive to this tracking, for future context specific reports generated for the specific user or a group of users, the processor may automatically adjust and/or rearrange the various icons of the context specific report in a manner such that the most selected icons are displayed in a position in the GUI that is most easily viewed by the user (e.g., in a center position of the GUI, in a descending order from a top left corner of the GUI, etc.). As another example, the user may manually adjust and/or rearrange the various icons by manually selecting the icons that are most used or most relevant to the user and dragging and dropping the icons to respective positions in the GUI based on the user preference.

At block 320, process 300 involves generating additional messages to be displayed. In some cases, a set of contacts may be identified and a set of messages requesting information may be sent to the set of contacts. However, it will be appreciated that some disparate entities may not respond to the request for information. As such, process 300 further includes generating additional messages to provide an indication to the requesting user that certain requested information was unavailable or not received. Block 320 may further include an option to share the context specific report with other disparate entities.

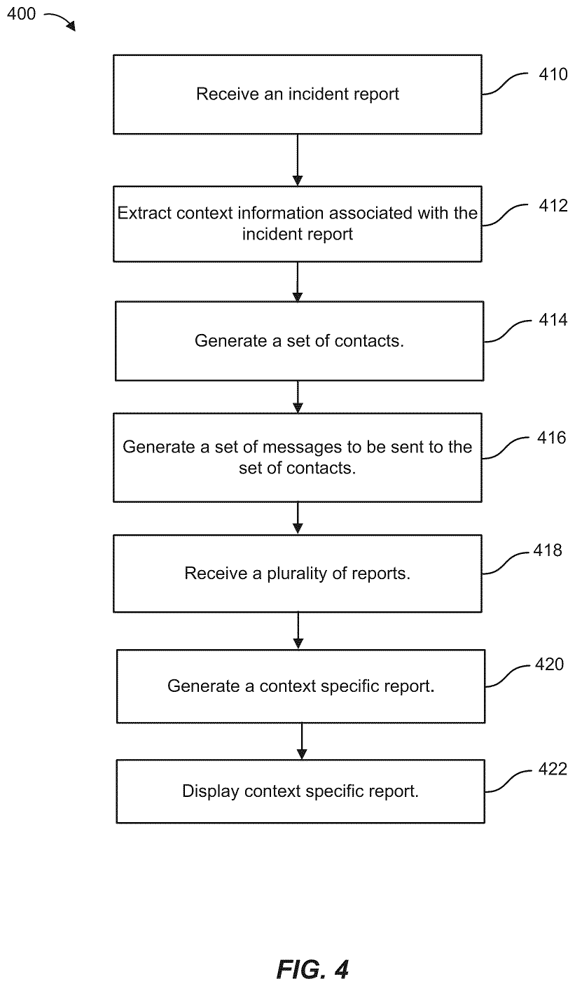

FIG. 4 illustrates a flow chart depicting process 400 for generating a context specific report from a plurality of disparate entities, according to an additional example. At block 410, process 400 involves accessing an incident report. In some examples, the incident report may be a vehicle incident report. In some examples, the incident report may be another type of report such as premise liability reports, arrest reports, medical incident reports, products liability reports, emergency response reports (e.g., fire, police, medical), and so on. In some examples, the incident report may be received directly from a user. In other examples, the incident report may be received automatically from an object involved in the incident. For example, an automobile involved in an accident may generate a report in response to the accident (e.g., by recording the time, location, speed of the vehicle, etc.). In some examples, the report may be generated in response to an event that occurs with the vehicle, such as an airbag deployment. The report and subsequent requests for information may be generated in response to “black box” recording devices incorporated into the vehicle. The report may be sent and received automatically and process 400 may proceed to analyze the received incident report.

At block 412, process 400 involves extracting context information associated with the incident report. Extracting context information can involve performing a scan of the incident report. The scan can include scanning the incident report to identify a unique document identifier embedded within the vehicle incident report. As mentioned with respect to FIG. 1, performing the scan of the incident report can be performed via the one or more processors of the computing device 102. Various methods for scanning documents can include, but are not limited to, scanning a quick response (QR) code or utilizing any suitable OCR techniques usable to extract text data from image data for further processing. As previously mentioned, the unique document identifier can be a barcode that contains information related to the incident. A barcode can be any form of a machine-readable optical image that contains information, such as a QR code, a universal product code (UPC), a data matrix, and the like. Additionally, the unique document identifier can be a precise incident location, where the precise incident location corresponds to global positioning system (GPS) coordinates including a latitude and longitude. Additionally, the unique document identifier can be a combination of GPS coordinates, a barcode, and any other information contained within a incident report such as report identification numbers, date, time, or names, for example.

At block 414, process 400 involves generating a set of contacts. The set of contacts can be determined based on the scanned unique document identifier information. Generating a set of contacts can involve determining, based on the unique document identifier information, all investigative and supporting agencies (e.g., disparate entities) with relevant information. For example, based on the precise location corresponding to the GPS coordinates, one investigative agency can include the local police department that was called in response to the vehicle incident report at that precise location, and thus, one contact, of the set of contacts, can be the local police department. Additionally, if the precise location on the vehicle incident report indicates the incident occurred on a state highway, for example, process 400 can recognize that a relevant investigative agency can be the state patrol office.

At block 416, process 400 involves generating a set of messages to be sent to the set of contacts. The set of messages can include requests for information based on the unique document identifier information. As another example, in the case where the incident report is received automatically from an object of the incident such as a vehicle reporting system (e.g., vehicle “black box” recording devices, responsive to airbag deployment, etc.), process 400 could generate the set of contacts based on local agencies associated with the name of the owner of the vehicle. For instance, process 400 could determine the local agencies based on extracting a location associated with an insurance policy on the vehicle, based on registration information of the vehicle, and so on. In these examples, the set of messages could include preemptive messages to the local agencies instructing the agencies to preserve records related to the incident.

As described herein, generation of the set of contacts and/or the set of messages may be performed using machine learning techniques. For instance, after extraction of context information from the vehicle incident report (e.g., scanning the vehicle incident report for a precise location) the precise location can be evaluated using a machine learning model trained by processing previous vehicle incident reports and their corresponding precise locations. The machine learning model can generate the set of contacts. The set of contacts can correspond to disparate entities holding relevant evidence related to the traffic event. As the machine learning can be trained by processing previous vehicle incident reports and their corresponding precise locations, the machine learning model can learn from past vehicle incident reports, past generations of the set of contacts, and past requests for information and their relative success rates in retrieving information related to a vehicle incident. Based on the relative success rates, the machine learning model can determine whether modifications should be made to the present set of contacts and requests for information to increase the likelihood of receiving the relevant information.

Furthermore, the machine learning model can determine, based on a classification of a user of the system (e.g., private citizen, attorney, claims adjustor, etc.) which information to request. For example, the machine learning model can identify that the requesting user is an attorney investigating a vehicle incident for purposes of a personal injury lawsuit. Accordingly, the machine learning model can identify, based on previous vehicle incidents involving attorneys and personal injury, that contacting the responding police department for body-camera footage of the scene to illustrate the injuries present at the time of the incident is the most valuable type of information for this type of user classification. Based on this determination, the machine learning model can generate a set of contacts (e.g., the local responding police department) and a set of messages containing legally compliant requests for information to obtain the body camera footage from the vehicle incident.

At block 418, process 400 involves receiving a plurality of reports from the various disparate entities corresponding to the set of contacts. The plurality of reports can be received via the network inface 112 described in relation to FIG. 1 and FIG. 2.

At block 420, process 400 involves generating a context specific report. The context specific report can be generated via the one or more processors of the computing device 102. The context specific report may include information received from the set of contacts. As mentioned with respect to FIG. 3, the context specific report may organize the received information in a manner that is easily read and viewed by the user. For instance, the processor may organize the information into a table, bullet point form, paragraph form, etc. Additionally, and as described with respect to FIG. 3, the context specific report can be an interactive GUI such that the displayed information in the context specific report may be adjusted and/or relocated for ease in viewing for the user based on manual adjustments performed by the user or based on automatic adjustments performed by the processor (e.g., via tracking the frequency of selected icons within the context specific report).

At block 422, process 400 involves displaying or otherwise transmitting the context specific report. As mentioned with respect to FIG. 3, display of the context specific report can involve displaying, on a graphical user interface of a user computing device, the context specific report. As mentioned previously with respect to FIG. 1, the user may view the context specific and in some cases, the user may share the context specific report with other entities.

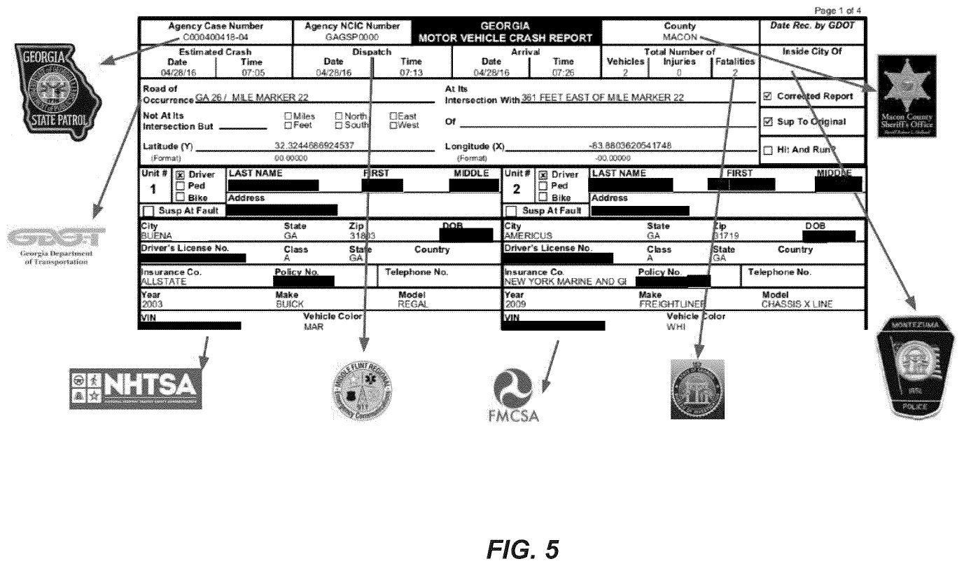

FIG. 5 illustrates an example vehicle incident report. The vehicle incident report illustrated in FIG. 5 can be used in conjunction with process 400 or can provide the user context information discussed in relation to FIG. 3, for example. As discussed above, the system can perform, via one or more processors, a scan of the vehicle incident report to identify a precise location of the vehicle incident. This is illustrated in FIG. 5 by the latitude (Y) and longitude (X) listed in the vehicle incident report. Other specific identifying information can also be scanned from the motor vehicle incident report, as discussed above in relation to FIG. 4. As also illustrated in FIG. 5, the various investigative and support agencies involved with a vehicle incident are highlighted. These investigative and supporting agencies can include, for example, the state patrol office, the state department of transportation, the National Highway Traffic Safety Administration (NHTSA), emergency communications department, the Federal Motor Carrier Safety Administration (FMCSA), the state bureau of investigation, the county police department, and the local city police department.

The example motor vehicle incident report of FIG. 5 highlights a problem the present disclosure seeks to address. Numerous agencies control important evidence, and thus, claims adjusters, private investigators, attorneys, and the like, spend time securing evidence from the numerous agencies. This process is not only inefficient, but often is not done due to the immense effort involved. As a result, financial resources are expended in settlements and needless litigation. The present disclosure seeks to solves this problem, as discussed above, by systems and methods for automatically requesting information from the numerous agencies (e.g., disparate entities) in a single request and providing the user (e.g., claims adjuster, private investigator, attorney, or citizen) with a generated context specific report of all the relevant evidence and information needed.

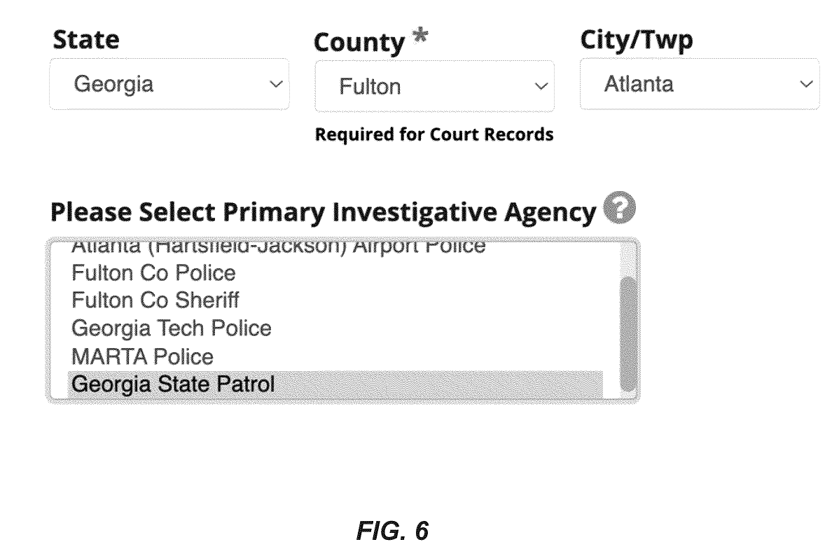

FIG. 6 illustrates an example user input interface according to an example of the presently disclosed subject matter. As illustrated in FIG. 6, a user can enter the location of an incident, such as a vehicle incident, and then select a primary investigative agency. The user input interface illustrated in FIG. 6 can correspond to input device 118 and display device 116 discussed above in relation to FIG. 1. Additionally, and as described above, the system, such as the system described in reference to FIG. 1 and FIG. 2, can utilize a machine learning model for selecting the primary investigative agency based on the user input data. For example, a machine learning model trained by processing previous vehicle incident reports and their corresponding precise location can be used to generate a set of contacts, wherein the set of contacts corresponds to a plurality of disparate entities holding relevant evidence related to the traffic event. The machine learning model can learn from past vehicle incident reports, past generation of a set of contacts, and past requests for information and their relative success rates in retrieving relevant evidence related to a vehicle incident report to determine whether modifications should be made to the present set of contacts and requests for information.

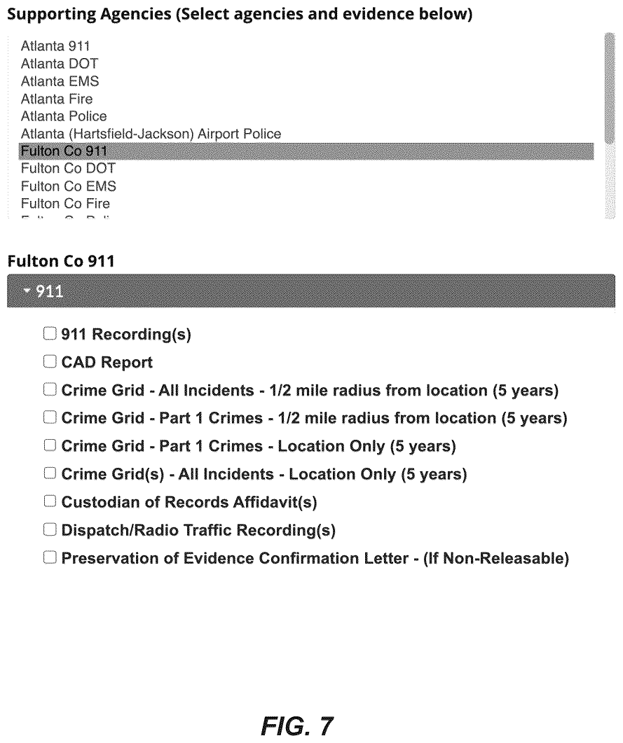

FIG. 7 illustrates an example of a user input interface according to an example of the presently disclosed subject matter. The example user input interface of illustrated in FIG. 7 can be displayed to a user after the user selects a primary investigative agency as discussed in relation to FIG. 6. In some examples, the system can recommend, via a machine learning model, various supporting agencies that can hold relevant evidence and information. The recommendations made by the machine learning model can be based on the historical success rates of receiving information from a particular agency. In other words, the machine learning model can recommend particular investigative or supporting agencies that have a historical high rate of responding to requests for information.

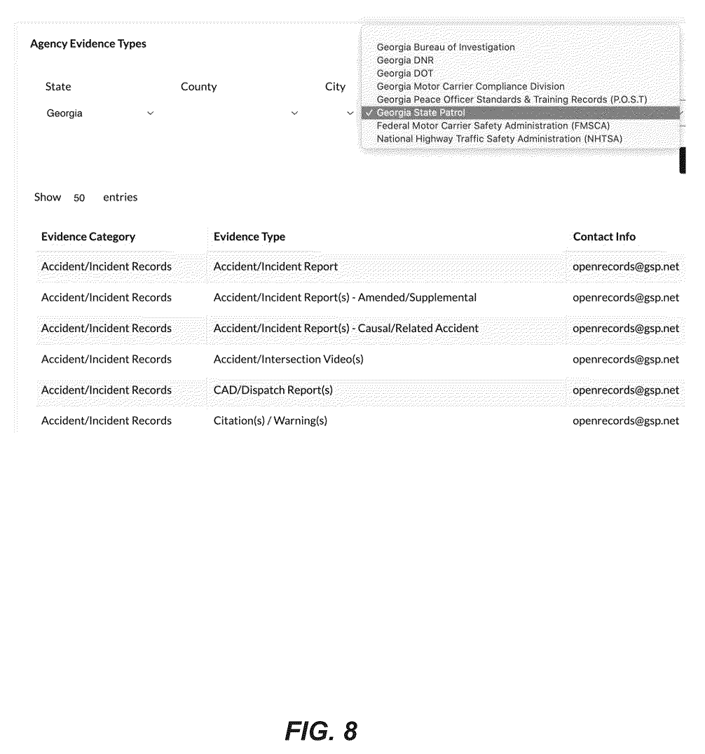

FIG. 8 illustrates an example set of contacts generated by a system based on the selected investigative agency and the selected supporting agency according to an example of the present disclosure. The set of contacts generated by the system can be displayed to the user after the user has selected the primary and investigative agencies from which the user seeks to request information. As illustrated by FIG. 8, each entity the user requests information from is assigned to a specific email contact.

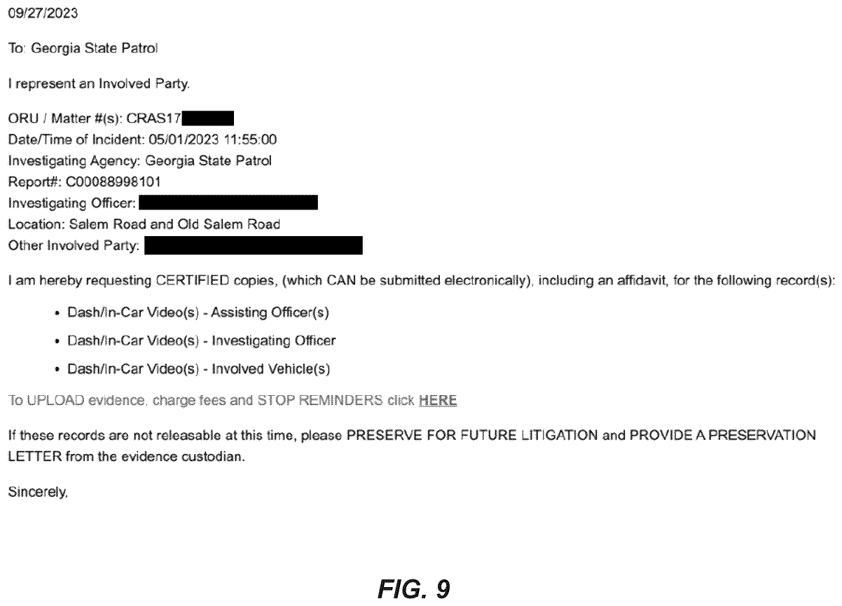

FIG. 9 illustrates an example message to be sent to the investigative or supporting agency according to an example of the presently disclosed subject matter. The example message illustrates a legally compliant records request and a secure link to share the evidence with the system. Once received by the system, a context specific report can be generated for the user to receive all requested evidence that was provided.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes,” “having,” “has,” “with,” or variants thereof are used in either the detailed description or the claims, such terms are intended to be inclusive in a manner similar to the term “comprising.” The use of “configured to” or “based on” herein is meant as open and inclusive language that does not foreclose devices adapted to or configured to perform additional tasks or steps. The endpoints of comparative limits are intended to encompass the notion of quality. Thus, expressions such as “more than” should be interpreted to mean “more than or equal to.”

Where devices, computing systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation and does not preclude inclusion of such modifications, variations, and/or additions to the present subject matter as would be readily apparent to one of ordinary skill in the art.

What is claimed is:

1. A method for automatic generation of requests for information, the method comprising:
receiving an incident report;
extracting context information associated with the incident report, wherein the context information comprises a set of attributes associated with an incident;
generating a set of contacts and a set of messages to be sent to the set of contacts based at least in part on the context information and an identity of a requesting user;
transmitting the set of messages to the set of contacts; and
generating and outputting, responsive to receiving information from the set of contacts, a context specific report containing the information received from the set of contacts.

2. The method of claim 1, wherein accessing the context information comprises extracting text data from the incident report.

3. The method of claim 2, wherein extracting text data from the incident report comprises performing optical character recognition (OCR) on the incident report.

4. The method of claim 1, wherein the method further comprises:
extracting from the incident report a precise location of an accident, the precise location comprising a latitude value and a longitude value, wherein the set of contacts are associated with a plurality of entities located within a predetermined distance from the precise location, within a defined jurisdictional boundary associated with the incident, or a combination thereof.

5. The method of claim 1, further comprising:
generating and outputting a set of additional messages, wherein the set of additional messages provide an indication that certain information was not received.

6. The method of claim 1, wherein the set of contacts and the set of messages are generated using a machine learning model.

7. The method of claim 6, wherein the machine learning model is trained to generate the set of contacts based on relative success rates that the set of contacts have responded to messages previously.

8. The method of claim 6, wherein the machine learning model is configured to:
analyze the incident report to identity a plurality of entities associated with the incident report; and
assign numerical weights to each entity of the plurality of entities, wherein the numerical weights are assigned based on a likelihood that each entity will respond to the set of messages, based on a relevancy of the information held by each entity, or a combination thereof.

9. The method of claim 8, wherein the machine learning model prioritizes sending the set of messages to entities with higher numerical weights by:
analyzing the numerical weight for each entity to generate a priority list having a descending order based on the numerical weights;
evaluating a respective numerical weight of an entity against a threshold; and
responsive to determining the threshold is satisfied, transmitting a message requesting information to the entity.

10. The method of claim 1, wherein the identity of the requesting user comprises an attorney, a police officer, a civilian, or a combination thereof, and wherein the identity is determined by extracting the identity from a profile associated with the requesting user.

11. The method of claim 1, wherein the set of attributes comprises an agency case number, a county and state, a time associated with the incident, a precise location of the incident based on global positioning coordinates, a name of a road, a plurality of party names involved in the incident, or any combination thereof.

12. The method of claim 1, wherein the context specific report is displayed on a graphical user interface (GUI) of a computer system, and wherein the method further comprises:
tracking, using a processor of the computer system, user selection of the information contained within the context specific report to determine an amount of use of each information of the context specific report; and
automatically rearranging the information in the GUI to display the most used information to an updated position within the GUI.

13. A system comprising:
one or more processors;
a memory coupled to the one or more processors, the memory including instructions that, when executed by the one or more processors, cause the one or more processors to:
receive an incident report;
extract context information associated with the incident report, wherein the context information comprises a set of attributes associated with an incident;
generate a set of contacts and a set of messages to be sent to the set of contacts based at least in part on the context information and an identity of a requesting user;
transmit the set of messages to the set of contacts; and
generate and output, responsive to receiving information from the set of contacts, a context specific report containing the information received from the set of contacts.

14. The system of claim 13, wherein accessing the context information comprises extracting text data from the incident report, and wherein extracting text data from the incident report comprises performing optical character recognition (OCR) on the incident report.

15. The system of claim 13, wherein the processor is further configured to:
extract from the incident report a precise location of an accident, the precise location comprising a latitude value and a longitude value, wherein the set of contacts are associated with a plurality of entities located within a predetermined distance from the precise location, within a defined jurisdictional boundary associated with the incident, or a combination thereof.

16. The system of claim 13, wherein the processor is further configured to:
generate and output a set of additional messages, wherein the set of additional messages provide an indication that certain information was not received.

17. The system of claim 13, wherein the set of contacts and the set of messages are generated using a machine learning model, and wherein the machine learning model is trained to generate the set of contacts based on relative success rates that the set of contacts have responded to messages previously.

18. The system of claim 17, wherein the machine learning model is configured to:
analyze the incident report to identity a plurality of entities associated with the incident report;
assign numerical weights to each entity of the plurality of entities, wherein the numerical weights are assigned based on a likelihood that the entity will respond to the set of messages, based on a relevancy of the information held by the entity, or a combination thereof;
analyze the numerical weight for each entity to generate a priority list having a descending order based on the numerical weights;
evaluate a respective numerical weight of an entity against a threshold; and
responsive to determining the threshold is satisfied, transmit a message requesting information to the entity.

19. The system of claim 13, wherein the context specific report is displayed on a graphical user interface (GUI) of the system, and wherein the processor is further configured to:
track user selection of the information contained within the context specific report to determine an amount of use of each information of the context specific report; and
automatically rearrange the information in the GUI to display the most used information to an updated position within the GUI.

20. A non-transitory computer-readable medium embodying program code that is executable by one or more processors to cause the one or more processors to:
receive an incident report;
extract context information associated with the incident report, wherein the
context information comprises a set of attributes associated with an incident;
generate a set of contacts and a set of messages to be sent to the set of contacts based at least in part on the context information and an identity of a requesting user;
transmit the set of messages to the set of contacts; and
generate and output, responsive to receiving information from the set of contacts, a context specific report containing the information received from the set of contacts.
